(19) United States
(12) Patent Application Publication
(10) Pub. No.: US 2008/0072696 A1
(43) Pub. Date: Mar. 27, 2008

(54) Mechanical arm

(76) Inventor: Victor Chen, Jubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/902,371

(22) Filed: Sep. 21, 2007

(30) Foreign Application Priority Data
Sep. 26, 2006 (TW) 095217175

(51) Int. Cl. G05G 1/00

(52) U.S. Cl. 74/469

(57) ABSTRACT

The present invention discloses a mechanical arm comprising an arm and a bearing bracket. The mechanical arm of the present invention is made of a ceramic material and has the characteristics of ceramic materials—high heat resistance, high abrasion resistance, high hardness, high strength, low friction coefficients and low thermal expansion coefficients. Thus, the mechanical arm of the present invention has less abrasion loss, less sway caused by over abrasion and less deformation caused by sway.

### BACKGROUND OF THE INVENTION

1. Field of the Invention

The present invention relates to a mechanical arm, particularly to a mechanical arm made of a ceramic material.

2. Description of the Related Art

All mechanical parts have their own service lives, which are influenced by many factors, including abrasion. None mechanical part can escape from abrasion. Abrasion will degrade precision of a mechanical part and cause sway or safety problems of the mechanical part. Therefore, reducing abrasion to increase service lives of mechanical parts is naturally a subject in the research and development of mechanical parts.

Traditional mechanical arms are usually made of iron, steel, alloy, etc. To reduce abrasion, the present invention proposes a mechanical arm made of a ceramic material, wherein the superior mechanical and physical properties of a ceramic material make the ceramic mechanical arm have a longer service life than a metallic mechanical arm.

### SUMMARY OF THE INVENTION

The primary objective of the present invention is to provide a mechanical arm made of a ceramic material, wherein the high strength and high abrasion resistance of a ceramic material can make the mechanical arm has a superior performance and a longer service life.

Another objective of the present invention is to provide a mechanical arm made of a ceramic material to reduce the fabrication cost thereof.

The present invention proposes a mechanical arm made of a ceramic material and comprising: an arm, a bearing bracket and a mesh member. The present invention also comprises a first mechanical arm horizontally symmetric to the mechanical arm. The first mechanical arm engages with the mechanical arm via the mesh members, and springs couple the first mechanical arm and the mechanical arm together to implement the actions of opening and closing.

Ceramic materials have superior properties. Thus, the ceramic mechanical arm of the present invention also has superior characteristics of ceramic materials. Further, ceramic materials are easier to acquire than the conventional material for mechanical arms. Besides, the process to fabricate mechanical arms with a ceramic material is simpler than that with the conventional materials. Therefore, the present invention can also reduce the cost of mechanical arms.

Below, the embodiments will be described in detail in cooperation with the attached drawings to make easily understood the objectives, technical contents, characteristics and accomplishments of the present invention.

### BRIEF DESCRIPTION OF THE DRAWINGS

FIG. 1 is a diagram schematically showing a mechanical arm according to the present invention;

FIG. 2 is another diagram schematically showing a mechanical arm according to the present invention;

FIG. 3 is a diagram schematically showing that bearings have not been installed on mechanical arms yet according to the present invention;

FIG. 4 is a diagram schematically showing that bearings have been installed on mechanical arms according to the present invention; and

FIG. 5 is a diagram schematically showing the operation of mechanical arms according to the present invention.

### DETAILED DESCRIPTION OF THE INVENTION

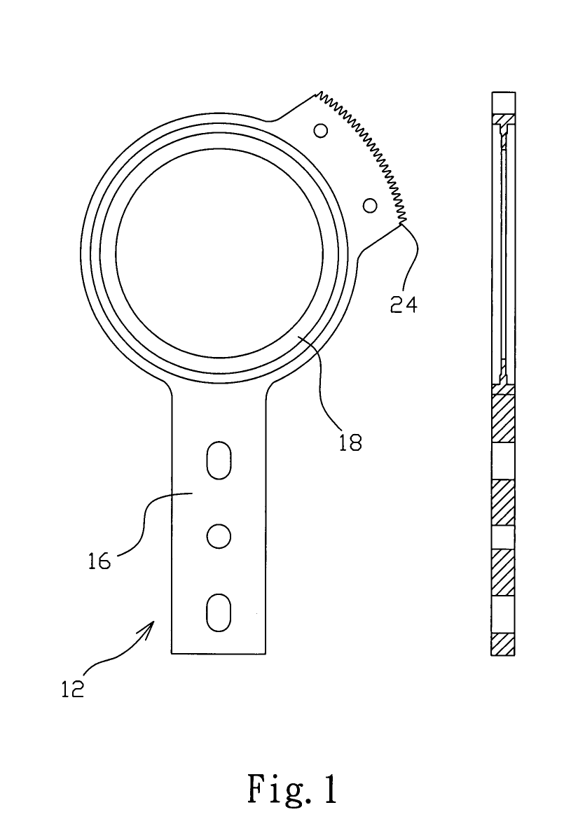

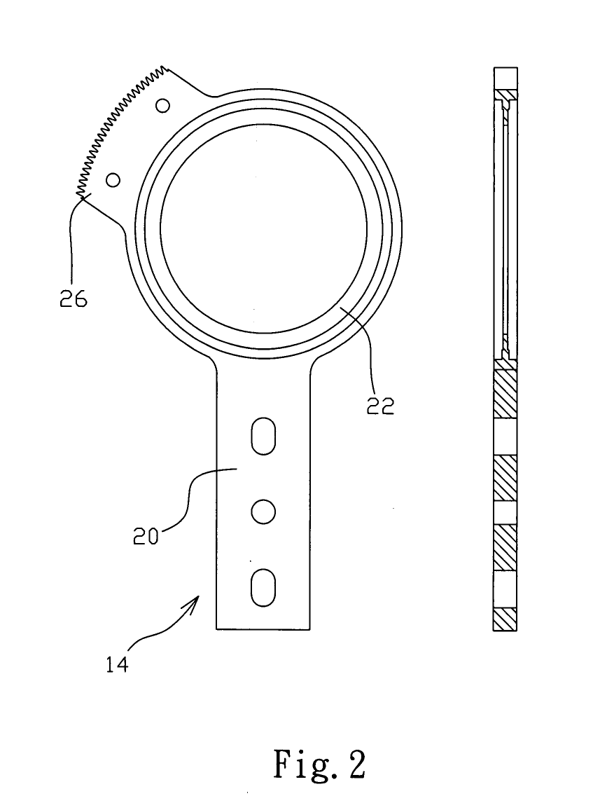

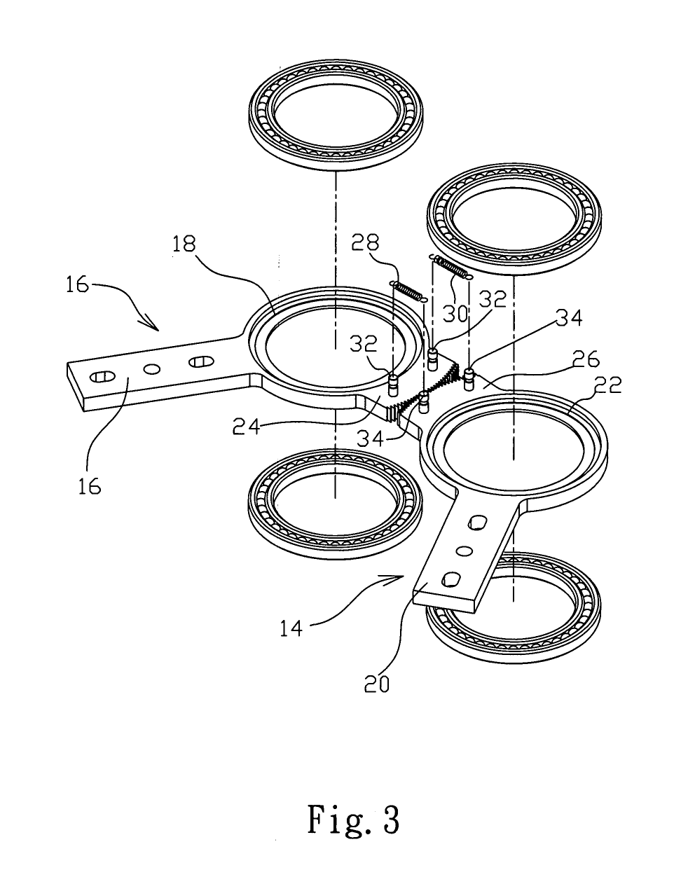

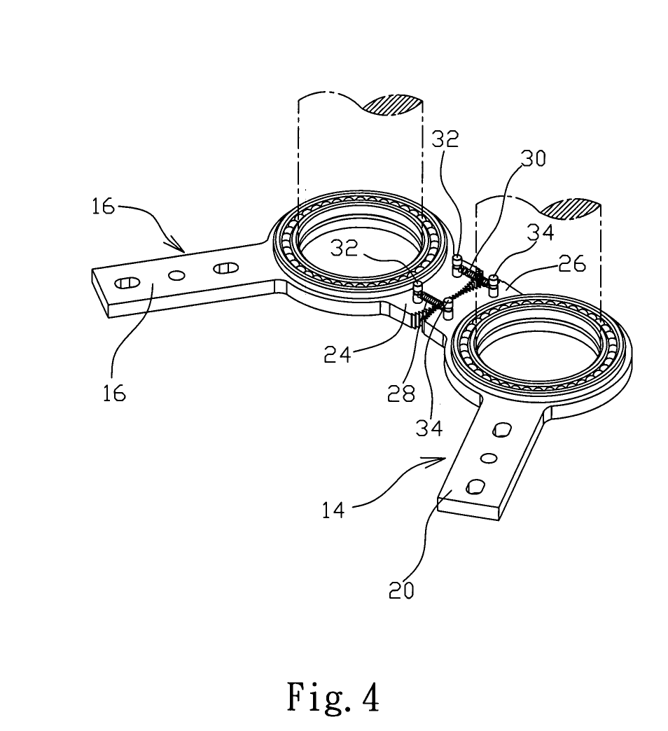

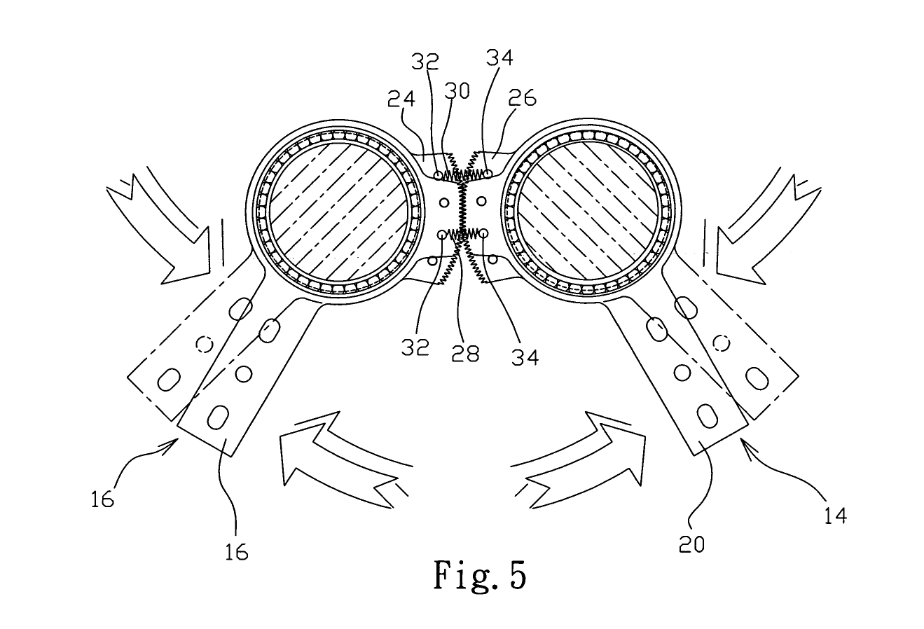

Refer to FIG. 1 and FIG. 2. The mechanical arms in FIG. 1 and FIG. 2 are horizontally symmetric and will be jointly described below. The mechanical arm 12/14 of the present invention comprises: an arm 16/20 and at least one bearing bracket 18/22. The mechanical arms 12 and 14 respectively have a mesh member 24 and a first mesh member 26. The mechanical arm 12 in FIG. 1 engages with the mechanical arm 14 in FIG. 2 via the mesh member 24 and the first mesh member 26. Both the mesh member 24 and the first mesh member 26 have a specification of 24 teeth per inch. In FIG. 1 and FIG. 2, the mechanical arm 12/14 has two bearing brackets 18/22 respectively on the upper and lower faces thereof. The bearing brackets 18 and 22 accommodate bearings (such as ball bearings) to couple the mechanical arms 12 and 14 together, as shown in FIG. 3 and FIG. 4. Refer to FIG. 5 for the operation of the mechanical arms 12 and 14. Pillars 32 and first pillars, 34 respectively extend outward from the mechanical arms 12 and 14. The pillars 32 are arranged in between the mesh member 24 and the bearing bracket 18. The first pillars 34 are arranged in between the first mesh member 26 and the bearing bracket 22. Two ends of a spring 28/30 are respectively fixed to the pillar 32 and the first pillar 34; thereby, the mechanical arms 12 and 14 are coupled together.

The mechanical arms 12 and 14 of the present invention have an outstanding characteristic that they are made of a ceramic material. In the present invention, the ceramic material of the mechanical arm is selected from a group consisting of silicon nitride (Si₃N₄), zirconium oxide (ZrO₂), and aluminum nitride (AlN). Obviously, the bearing may also be made of a ceramic material, such as silicon nitride (Si₃N₄), zirconium oxide (ZrO₂), or aluminum nitride (AlN).

Ceramic materials have the characteristics of high fire resistance, high heat resistance, high abrasion resistance, high hardness, high strength, low friction coefficients and low thermal expansion coefficients. Naturally, the mechanical arm made of a ceramic material can endure high temperature and abrasion. Thus, the ceramic mechanical arm of the present invention has the superior characteristics of ceramic materials. Further, ceramic materials are easier to acquire than the conventional material for mechanical arms. Besides, the process to fabricate mechanical arms with a ceramic material is simpler than that with the conventional materials. Therefore, the present invention can also reduce the cost of mechanical arms.

Those described above are only the preferred embodiments to exemplify the present invention but not to limit the scope of the present invention. Any equivalent modification or variation according to the shapes, structures, characteristics and spirit disclosed in the present invention is to be also included within the scope of the present invention.

What is claimed is:

1. A mechanical arm, made of a ceramic material and comprising: an arm, a bearing bracket, a mesh member and at least one set of pillars, wherein said mesh member engages with a corresponding mechanical arm via a meshing method, and wherein said pillars are arranged in between said mesh member and said bearing bracket and extend outward from said arm.

2. A mechanical arm according to claim 1, wherein said bearing bracket can accommodate at least one bearing.

3. A mechanical arm according to claim 1, wherein said ceramic material is selected from a group consisting of silicon nitride (Si₃N₄), zirconium oxide (ZrO₂), and aluminum nitride (AlN).

4. A mechanical arm according to claim 2, wherein said bearing is made of a ceramic material.

5. A mechanical arm according to claim 4, wherein said ceramic material for said bearing is selected from a group consisting of silicon nitride (Si₃N₄), zirconium oxide (ZrO₂), and aluminum nitride (AlN).

6. A mechanical arm according to claim 1 further comprising a first mechanical arm, which is arranged in one side of said mechanical arm and horizontally symmetric to said mechanical arm, wherein said first mechanical arm includes: a first mesh member and a set of first pillars, wherein said first mesh member engages with said mesh member to enable said first mechanical arm and said mechanical arm to operate simultaneously.

7. A mechanical arm according to claim 6, wherein both said first mesh member and said mesh member have a specification of 24 teeth per inch.

8. A mechanical arm according to claim 6, wherein two ends of a spring are respectively fixed to said pillar and said first pillar to couple said mechanical arm and said first mechanical arm together.
